(19) United States
(12) Patent Application Publication
(10) Pub. No.: US 2002/0194506 A1
(43) Pub. Date: Dec. 19, 2002

(54) Internet service provider method and apparatus

(76) Inventors: Anthony J. Wiley, Bristol (GB); David Murray Banks, Bristol (GB)

Correspondence Address: HEWLETT-PACKARD COMPANY, Intellectual Property Administration, P.O. Box 272400, Fort Collins, CO, 80527-2400, US

(21) Appl. No.: 10/166,600

(22) Filed: Jun. 12, 2002

(30) Foreign Application Priority Data
Jun. 19, 2001 (GB) 0114901.2

(51) Int. Cl. H04L 9/00

(52) U.S. Cl. 713/201

(57) ABSTRACT

A method and apparatus for use in an internet service provider environment (10), for providing internet (20) access to a plurality of subscriber environments. A packet intended for a destination subscriber environment is discriminated to deny the packet if it is considered insecure. Performing this discrimination in the internet service provider environment (10) allows a centralized security service for a large number of subscriber environments (30) each having internet access through the internet service provider environment (10). Each subscriber environment (30) is maintained in a secure state to inhibit subversion such as by malicious attacks, even where the subscriber environment (30) is allocated a static IP address and maintains connection for a relatively long duration session. Also, technical expertise required of a subscriber operating the subscriber environment (30) is minimized.

### FIELD OF THE INVENTION

The present invention relates in general to an apparatus and method for providing internet access to a plurality of subscribers, as used by an Internet Service Provider (ISP).

### BACKGROUND OF THE INVENTION

Use of a global data communications network such as the internet is widespread and has increased substantially in recent years. More recently, networks such as Wireless Application protocol (WAP) are being used. Commonly, a subscriber couples their user apparatus (e.g. a personal computer) to the global data network through an ISP, using a telecommunications link such as an analogue or digital subscriber telephone line. A problem has been identified in that the connection to the internet provides a point of entry into the subscriber user apparatus which can be exploited to subvert the user apparatus, particularly by a malicious attack from another subscriber. Therefore, it is desired to reduce the vulnerability of user apparatus to subversion.

Attempts have been made to improve security of user apparatus by providing security applications running on the user apparatus, or by providing firewall devices arranged locally thereto. However, a significant proportion of ordinary subscribers lack the technical expertise required to correctly install and configure available security applications and firewall devices. In particular, security applications and firewall devices offering a relatively high degree of security are currently limited to use by experts or within corporate fields due to cost and required technical expertise. The vulnerability of user apparatus is expected to increase as new generations of telecommunications links are introduced, such as always-on subscriber telecommunications links.

### SUMMARY OF THE INVENTION

An aim of the present invention is to provide a method and apparatus which increases security for a subscriber user apparatus. A preferred aim is to provide a method and apparatus for reducing the risk of subversion, which is simple, convenient and cost-effective for the subscriber, and preferably which minimises the level of technical expertise required of the subscriber.

According to the first aspect of the present invention there is provided a method for use in an internet service provider environment for providing internet access to a plurality of subscriber environments, comprising the steps of: receiving a packet intended for a destination subscriber environment amongst the plurality of subscriber environments; discriminating the packet to deny the packet if considered insecure; else passing the packet toward the destination subscriber environment.

Preferably, the method comprises receiving a subscription from one or more of the subscriber environments to a centralised security service, and selectively discriminating the packet only if the destination subscriber environment has subscribed to the centralised security service.

Preferably, the discriminating step comprises applying one or more discriminating filters according to a level of service subscribed to by the destination subscriber environment.

According to a second aspect of the present invention there is provided a method of providing internet access to a plurality of subscriber environments by an internet service provider environment, comprising the steps of: receiving a security subscription from one or more of the plurality of subscriber environments; receiving a packet intended for a destination subscriber environment amongst the plurality of subscriber environments; if a security subscription has been received from the destination subscriber environment, then discriminating the packet with reference to one or more discriminating filters to deny the packet if considered insecure; else passing the packet for delivery to the destination subscriber environment.

Preferably, the method comprises forming a security policy for a subscriber environment in response to receiving a security subscription; and discriminating a packet for a destination subscriber environments in accordance with the security policy for that subscriber environment. Preferably, the method comprises storing the security policy in a security subscription table comprising security policy records indexed by an IP address allocated to each subscriber environment. Preferably, the method comprises retrieving a stored security policy for a destination subscriber environment according to a destination IP address of the packet.

Preferably, the received security subscription determines a level of service for the subscriber environment; and the discriminating step includes selecting one or more discriminating filters to apply to the packet according to the level of service for the destination subscriber environment.

Preferably, the discriminating step comprises any one or more of: (a) comparing a source IP address of the packet against one or more control lists; (b) determining whether the packet is a response to a request from within the destination subscriber environment; and (c) discriminating the packet according to its content, or the application type of its content.

According to a third aspect of the present invention there is provided an internet service provider apparatus providing internet access to a plurality of subscriber environments, the apparatus comprising: an edge router coupleable to core routers of a global data network; an ISP telecommunications interface coupleable to a plurality of subscriber environments; and a packet discriminator arranged to discriminate packets passing between the edge router and the ISP telecommunications interface.

Preferably, the packet discriminator comprises at least one discriminating filter.

Preferably, the packet discriminator comprises an IP packet filter arranged to discriminate packets by comparing a source IP address of a packet against one or more control lists.

Preferably, the packet discriminator comprises at least one application level filter arranged to discriminate a packet according to content and application type.

Preferably, the packet discriminator comprises a HTTP response filter arranged to discriminate packets according to responses requested from within a subscriber environment.

Preferably, the packet discriminator performs packet discrimination selectively according to a destination IP address of each packet.

Preferably, the packet discriminator performs packet discrimination only for one or more subscriber environments which have subscribed to a centralised security service. Preferably, the packet discriminator performs packet discrimination according to a level of service which has been subscribed to by the one or more subscriber environments. Preferably, the packet discriminator performs packet discrimination by applying a selected one or more discriminating filters according to the level of service.

Preferably, the packet discriminator performs packet discrimination of a packet destined for a destination subscriber environment amongst the plurality of subscribers environments, in accordance with a stored security policy for the destination subscriber environment. Preferably, the stored security policy includes a security subscription table comprising security profile records indexed by an IP address allocated to each subscriber environment.

According to a fourth aspect of the present invention there is provided an apparatus providing internet access to a plurality of subscriber environments from an internet service provider environment, the apparatus comprising: a packet discriminator arranged to discriminate a packet destined for a destination subscriber environment amongst the plurality of subscriber environments, by applying zero or more discriminating filters according to a level of service subscribed to by the destination subscriber environment.

According to a fifth aspect of the present invention there is provided a system connecting a subscriber user apparatus to a global data network, comprising: a subscriber telecommunications interface coupled to the subscriber user apparatus; a telecommunications environment coupled to the subscriber telecommunications interface; and an internet service provider environment coupled to the telecommunications environment, the internet service provider environment including an edge router coupleable to the global data network, an ISP telecommunications interface coupled to the telecommunications environment, and a packet discriminator arranged to discriminate packets passing between the edge router and the ISP telecommunications interface.

### BRIEF DESCRIPTION OF THE DRAWINGS

For a better understanding of the invention, and to show how embodiments of the same may be carried into effect, reference will now be made, by way of example, to the accompanying diagrammatic drawings in which:

FIG. 1 is a general overview of a typical system for connecting a subscriber user apparatus to the internet;

FIG. 2 shows a preferred system for coupling a subscriber to the internet, including a preferred apparatus for use in an internet service provider environment;

FIG. 3 shows a preferred packet discriminator apparatus for use in an ISP environment; and

FIG. 4 shows a preferred security policy; and

FIG. 5 shows a preferred method for providing a centralised security service in an ISP environment.

### DESCRIPTION OF PREFERRED EMBODIMENT

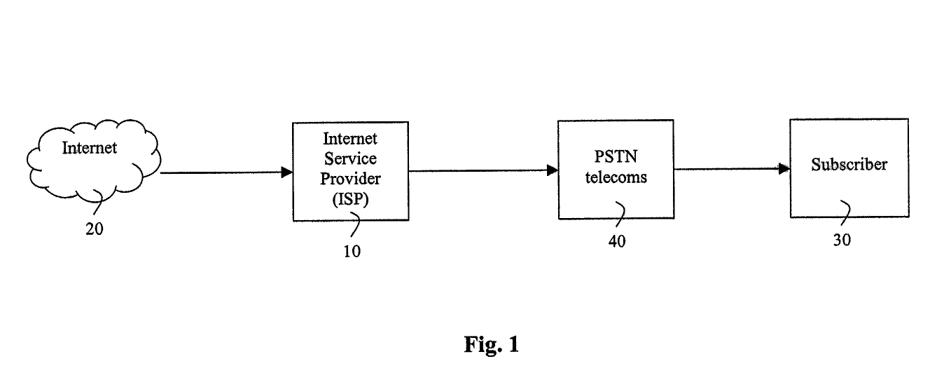

FIG. 1 is a general overview showing an example system for coupling a subscriber environment to a global data communications network such as the internet. An ISP (Internet Service Provider) environment 10 provides an interface between the internet environment 20 and the subscriber environment 30. Typically, many subscriber environments 30 are coupled through a single ISP environment 20, and only one subscriber environment 30 is shown for ease of explanation.

Typically, the subscriber environment 30 is coupled to the ISP environment 10 through a telecommunications environment 40 such as a public switched telephone network (PSTN). In the most common currently available networks, subscriber lines are coupled through an exchange network, allowing a direct communications path to be selectively established between the subscriber environment 30 and the ISP environment 10 for the duration of a telephone call. Subscribers send and receive information in discrete packets, such as according to an internet protocol (IP) for transmission of data. The subscriber environment 30 is usually allocated an IP address which changes for each session established between the subscriber environment 30 and the ISP environment 10. In this relatively widely used system, the subscriber environment 30 connects with the ISP 10 for a session of relatively short duration e.g. minutes or hours), giving only a relatively short window of opportunity for an attacker to attempt subversion. A typical attack may involve attempts to gain information about the nature of a subscriber environment 30 at a particular IP address, which information can then be used to attempt subversion of the user apparatus. With the advent of more advanced telecommunications environments 40 such those employing ADSL (Asymmetric Digital Subscriber Line) modem technology, and favourable call charging arrangements, there is a tendency for the subscriber environment 30 to remain connected for a longer period and/or to maintain a relatively static IP address, each of which increase the window of opportunity for an attacker to attempt subversion.

The subscriber environment 30 may take any suitable form. For example, the subscriber environment 30 comprises computing equipment belonging to an individual, a corporation, or an organisation of other legal status. That is, the subscriber environment 30 is owned and operated by a legal entity such as an individual or corporation. An internet service provider (ISP) is a company or organisation controlling the ISP environment 10, thereby providing internet access to a plurality of subscriber environments 30.

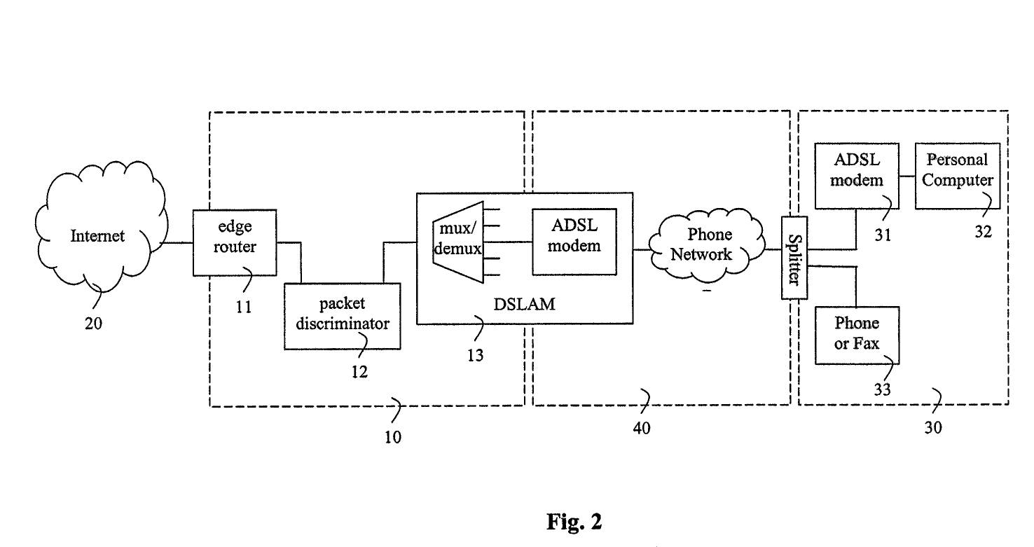

FIG. 2 is a more detailed schematic diagram showing a preferred system for coupling an example subscriber environment 30 to the internet 20. The subscriber environment 30 comprises a subscriber telecommunications interface 31 which in this example is an ADSL modem, coupled to a subscriber user apparatus 32 such as a personal computer. The subscriber telecommunications interface 31 and the user apparatus 32 are separate devices or can be integrated into a single device. The user apparatus can take any suitable form, such as a personal computer, a personal digital assistant, an internet television, a video telephone, a WAP cellular telephone, or other multimedia device. Other user apparatus can be provided coupled to the same subscriber telecommunications interface 31, such as a voice telephone or fax machine 33. In this case, the telecommunications interface 31 preferably includes a splitter which frequency division multiplexes phone and ADSL carriers from the subscriber line. The telecommunications environment 40 is suitably a fixed-line network (e.g. PSTN). In other example preferred embodiments, the telecommunications environment 40 comprises a cellular radio communications network.

The ISP environment 10 comprises an edge router 11, an ISP telecommunications interface 13, and a packet discriminator 12. Preferably, the packet discriminator 12 is located between the edge router 11 and the ISP telecommunications interface 13. Preferably the packet discriminator 12 is arranged logically adjacent to the edge router, and preferably immediately behind the edge router 11. The edge router 11 is arranged to form part of a global data communications network, such as by being coupled to core routers (not shown) in the internet environment 20. The ISP telecommunications apparatus 13 is arranged to interface with the telecommunications network 40, and suitably comprises a multiplexer/demultiplexer and an ADSL modem which together form a DSLAM (Digital Subscriber Line Access Multiplexer).

The packet discriminator 12 is arranged to discriminate packets of information passing through the ISP environment 10, and in particular is arranged to discriminate packets moving from the internet environment 20 toward the subscriber environment 30. Suitably, discrimination of packets is performed in accordance with a predetermined security policy, whereby it is determined whether to pass or deny each packet.

In the preferred embodiment, all packets intended for the subscriber environment 30 are routed through the packet discriminator 12. In an alternative embodiment, the packet discriminator is arranged to non-intrusively monitor packets passing towards the subscriber environment 30, and selectively deny packets which do not meet the predetermined security policy.

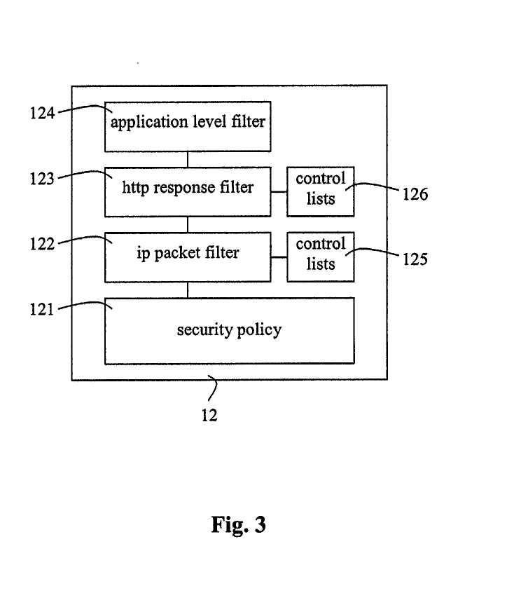

FIG. 3 shows a schematic overview of an example packet discriminator employed in preferred embodiments of the present invention. The packet discriminator 12 comprises one or more discriminating filters 122, 123 & 124 which are preferably applied in accordance with a stored security policy 121. One or more of the discriminating filters may make use of an access control list or lists 125,126.

As a first example, the discriminating filters comprise an IP packet filter 122. The IP packet filter 122 is arranged to discriminate packets based upon source and/or destination IP address, suitably by comparing the source and/or destination address against one or more access control lists 125. Preferably, packets originating from source addresses considered insecure are denied. Advantageously, the IP packet filter 122 involves relatively minimal processing power, achieving high throughput for relatively low resource usage in the ISP environment 10. Hence, the IP packet filter 122 is relatively efficient to implement.

In a second example the discriminating filters include at least one application level filter 123, 124. The or each application level filter 123, 124 is arranged to filter packets in accordance with criteria appropriate to a particular application used by the subscriber environment 30. Each application level discriminating filter is suitably arranged to look inside each packet which is desired to discriminate, and apply a discriminating function in accordance with a particular application or set of applications. As one example, the application level filter 124 is arranged to either allow or deny packets which contain real media or streaming media, in accordance with the stored security policy. Many other discriminating filters, particularly other application level filters, can be provided as appropriate to the nature of the packets being passed toward the subscriber environment 30 and according to the needs of the or each application running in the subscriber environment 30. Application level filters 123 and 124 require additional processing resources in the ISP environment, but provide increased security for the subscriber environment 30 compared with the relatively simple IP packet filter 122.

As one option, the application level filter is a HTTP response filter 123. The HTTP response filter 123 is arranged to allow packets only in response to a request originating in the subscriber environment 30. Suitably, the HTTP response filter examines request or response information inside each packet, to determine whether the packet is a response to a request from within the subscriber environment 30. Advantageously, the subscriber environment 30 only receives packets in response to requests made in that environment. Packets which are not a response to a request are deemed to be insecure and are denied. The HTTP response filter 123 suitably operates by consulting a control list or lists 126 containing source IP addresses. The control list is updated, for example, each time a user issues a request for information from a particular source, such that a response from that source is passed by the HTTP response filter 123. The control list or lists used by the HTTP response filter are suitably maintained at least for a complete session with the subscriber environment 30, or are maintained for a predetermined time period, or other condition.

In another option, the application level filter is a TCP connection tracker 124. The TCP connection tracker maintains one or more tables of connections, preferably each associated with a state of the connection. Suitably, the TCP connection tracker discriminates packets to only allow outbound TCP connections to be initiated, from the subscriber environment 30. Advantageously, when a session is terminated, the tables associated with the subscriber environment 30 are emptied or deleted.

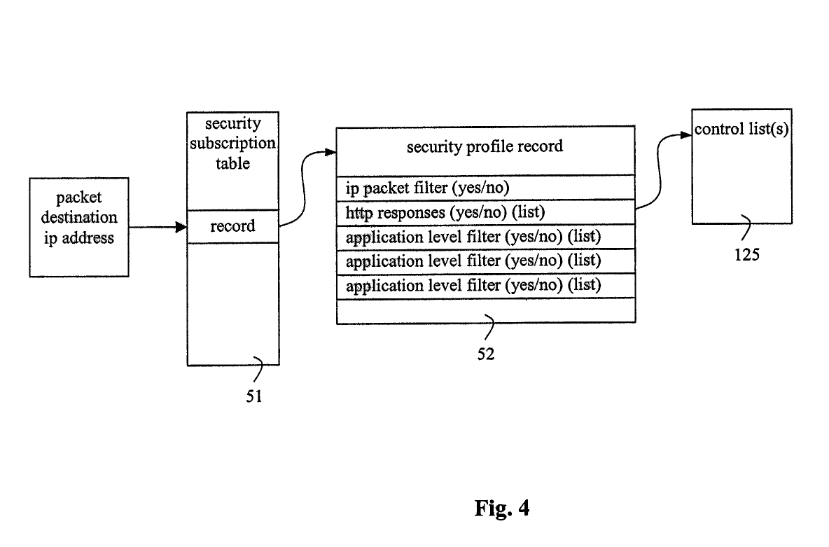

FIG. 4 shows a preferred example of the stored security policy 121 used by the packet discriminator 12. In a first practical implementation, the same security policy is applied to all of a plurality of subscriber environments 30 coupled to the ISP environment 10. In a second preferred implementation the ISP operator offers the centralised security service as an option to each subscriber, for example as an additional cost to a monthly subscription. Further preferably, the ISP operator offers at least two different levels of service for the centralised security service. For example, the first level involves only IP packet filtering, whilst the second level includes both IP packet filtering and at least one application level filter. Suitably, subscriber environments 30 are grouped according to a level of security service (e.g. no service, first level or second level). Further levels of granularity can be provided, for example up to a level where each subscriber environment 30 has an individual security policy determined by preferences of the subscriber.

As shown in FIG. 4, the destination IP address of a packet is conveniently used as an index in a security subscription table 51. The resulting security profile record 52 contains a security profile appropriate to that destination IP address. Where, as in the example mentioned above, the centralised security service is offered as an option then subscriber environments which have chosen not to subscribe to the security service conveniently return a blank security profile record and the packet is immediately passed toward the subscriber environment. Alternatively, the IP address allocated to the subscriber environment 30 for a particular session is conveniently grouped according to the level of security service subscribed to by that subscriber. Where the subscriber environment 30 has chosen to subscribe to the centralised security service offered by the ISP operator, then the security profile record contains the security profile appropriate to that subscriber environment 30. Suitably, the security profile record determines the discriminating filter or discriminating filters 122-124 which should be applied to that packet. Also, the security profile record 52 conveniently provides a reference to one or more associated control lists 125, 126 relevant to that filter and/or that subscriber. Suitably, the subscription table 51 is updated at the start and end of each session with a subscriber environment 30, in particular to associate a security profile record 52 with the IP address allocated to the subscriber environment 30 for that session.

Suitably, the subscriber environment 30 registers a preferred security profile in the security subscription table 51 by supplying a key to a security profile record 52, for example at the beginning of each session. Conveniently, the security profile record 52 is established for particular subscriber environment 30 at the point where the subscriber environment 30 first subscribes to the centralised security service, or the desired level of service. Therefore, it is relatively easy for the ISP operator to maintain the security subscription table and the relationship between the assigned IP address for that subscriber environment and the security profile record.

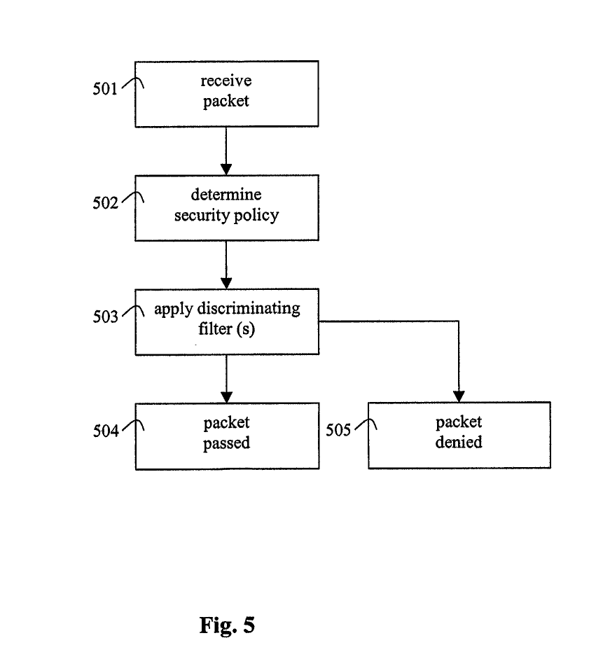

FIG. 5 shows a preferred method for providing a centralised security service in an ISP environment. The method is particularly suited for use with the apparatus described above with reference to FIGS. 1 and 2, and preferably makes use of the packet discriminator described with reference to FIGS. 3 and 4.

In the preferred method, step 501 comprises receiving a packet, such as from the edge router 11, intended for and travelling toward the subscriber environment 30.

Optionally, step 502 comprises determining a security policy to be applied to the packet. Preferably, the security policy 121 is determined with reference to the destination IP address of the packet, which corresponds to the subscriber environment 30, such as described with reference to FIGS. 3 and 4.

Step 503 comprises applying one or more discriminating filters, such as the IP packet filter 122 and/or one or more application level filters 123, 124. Preferably, the one or more discriminating filters are selected from amongst a plurality of available discriminating filters, in response to the determined security policy 121. This step can be repeated many times according to the filters required for a particular packet. Suitably, the one or more filters are applied in a predetermined sequence, which sequence can be determined in accordance with the stored security policy 121. A packet not denied by any of the one or more applied discriminating filters is passed in step 504. If a packet fails any of the discriminating filters then the packet is denied in step 505. For example, step 505 comprises returning the packet to the source as being undeliverable.

A method and apparatus have been described for providing a centralised security service in an ISP environment 10 which advantageously enhances security for a subscriber environment 30 coupled to the ISP environment, whilst removing burdens of cost and complexity from the subscriber environment. The preferred method and apparatus is flexible and can be adapted even to the level of individual subscriber environments. Advantageously, the security service can be operated and maintained by skilled and knowledgeable operators working in the ISP environment. The method and apparatus are particularly useful where each session lasts for a relatively long period of time, which would otherwise give a relatively lengthy window of opportunity for a malicious attacker to attempt subversion of the subscriber environment.

1. A method for use in an internet service provider environment for providing internet access to a plurality of subscriber environments, comprising the steps of:
receiving a packet intended for a destination subscriber environment amongst the plurality of subscriber environments;
discriminating the packet to deny the packet if considered insecure; else
passing the packet toward the destination subscriber environment.

2. The method of claim 1, comprising receiving a subscription from one or more of the subscriber environments to a centralised security service, and selectively discriminating the packet only if the destination subscriber environment has subscribed to the centralised security service.

3. The method of claim 1, wherein the discriminating step comprises applying one or more discriminating filters according to a level of service subscribed to by the destination subscriber environment.

4. A method of providing internet access to a plurality of subscriber environments by an internet service provider environment, comprising the steps of:
receiving a security subscription from one or more of the plurality of subscriber environments;
receiving a packet intended for a destination subscriber environment amongst the plurality of subscriber environments;
if a security subscription has been received from the destination subscriber environment, then discriminating the packet with reference to one or more discriminating filters to deny the packet if considered insecure; else
passing the packet for delivery to the destination subscriber environment.

5. The method of claim 4, comprising:
forming a security policy for a subscriber environment in response to receiving a security subscription; and
discriminating a packet for a destination subscriber environments in accordance with the security policy for that subscriber environment.

6. The method of claim 5, comprising storing the security policy in a security subscription table comprising security policy records indexed by an IP address allocated to each subscriber environment.

7. The method of claim 6, comprising retrieving a stored security policy for a destination subscriber environment according to a destination IP address of the packet.

8. The method of claim 4, wherein the received security subscription determines a level of service for the subscriber environment; and the discriminating step includes selecting one or more discriminating filters to apply to the packet according to the level of service for the destination subscriber environment.

9. The method of claim 4, wherein the discriminating step comprises any one or more of:
(a) comparing a source IP address of the packet against one or more control lists;
(b) determining whether the packet is a response to a request from within the destination subscriber environment; and
(c) discriminating the packet according to its content, or the application type of its content.

10. An internet service provider apparatus providing internet access to a plurality of subscriber environments, the apparatus comprising:
an edge router coupleable to core routers of a global data network;
an ISP telecommunications interface coupleable to a plurality of subscriber environments; and
a packet discriminator arranged to discriminate packets passing between the edge router and the ISP telecommunications interface.

11. The apparatus of claim 10, wherein the packet discriminator comprises at least one discriminating filter.

12. The apparatus of claim 10, wherein the packet discriminator comprises an IP packet filter arranged to discriminate packets by comparing a source IP address of a packet against one or more control lists.

13. The apparatus of claim 10, wherein the packet discriminator comprises at least one application level filter arranged to discriminate a packet according to content and application type.

14. The apparatus of claim 10, wherein the packet discriminator comprises a HTTP response filter arranged to discriminate packets according to responses requested from within a subscriber environment.

15. The apparatus of claim 10, wherein the packet discriminator performs packet discrimination selectively according to a destination IP address of each packet.

16. The apparatus of claim 10, wherein the packet discriminator performs packet discrimination only for one or more subscriber environments which have subscribed to a centralised security service.

17. The apparatus of claim 16, wherein the packet discriminator performs packet discrimination according to a level of service which has been subscribed to by the one or more subscriber environments.

18. The apparatus of claim 17, wherein the packet discriminator performs packet discrimination by applying a selected one or more discriminating filters according to the level of service.

19. The apparatus of claim 10, wherein the packet discriminator performs packet discrimination of a packet destined for a destination subscriber environment amongst the plurality of subscribers environments, in accordance with a stored security policy for the destination subscriber environment.

20. The apparatus of claim 19, wherein the stored security policy includes a security subscription table comprising security profile records indexed by an IP address allocated to each subscriber environment.

21. An apparatus providing internet access to a plurality of subscriber environments from an internet service provider environment, the apparatus comprising:
a packet discriminator arranged to discriminate a packet destined for a destination subscriber environment amongst the plurality of subscriber environments, by applying zero or more discriminating filters according to a level of service subscribed to by the destination subscriber environment.

22. A system connecting a subscriber user apparatus to a global data network, comprising:
a subscriber telecommunications interface coupled to the subscriber user apparatus;
a telecommunications environment coupled to the subscriber telecommunications interface; and
an internet service provider environment coupled to the telecommunications environment, the internet service provider environment including an edge router coupleable to the global data network, an ISP telecommunications interface coupled to the telecommunications environment, and a packet discriminator arranged to discriminate packets passing between the edge router and the ISP telecommunications interface.
